(19) United States
(12) Patent Application Publication
(10) Pub. No.: US 2006/0239481 A1
(43) Pub. Date: Oct. 26, 2006

(54) Method for producing a hearing device component and a mold therefor, and component and mold produced by the method

(76) Inventor: Raimund Martin, Eggolsheim (DE)

Correspondence Address: SCHIFF HARDIN, LLP;PATENT DEPARTMENT, 6600 SEARS TOWER, CHICAGO, IL, 60606-6473, US

(21) Appl. No.: 11/389,373

(22) Filed: Mar. 24, 2006

(30) Foreign Application Priority Data
Mar. 24, 2005 (DE) 10 2005 013 834.9

(51) Int. Cl. H04R 25/00

(52) U.S. Cl. 381/312

(57) ABSTRACT

The wearing comfort of a hearing device or of an ear fitting piece is increased by a method for production of a hearing device component and corresponding hearing device component wherein a three-dimensional model of this hearing device component is provided and is calculated there from a negative form of the hearing device component to be produced. An injection mold for the hearing device component is fashioned from this. The hearing device component is finally cast with the aid of the injection mold, such as with an elastic material.

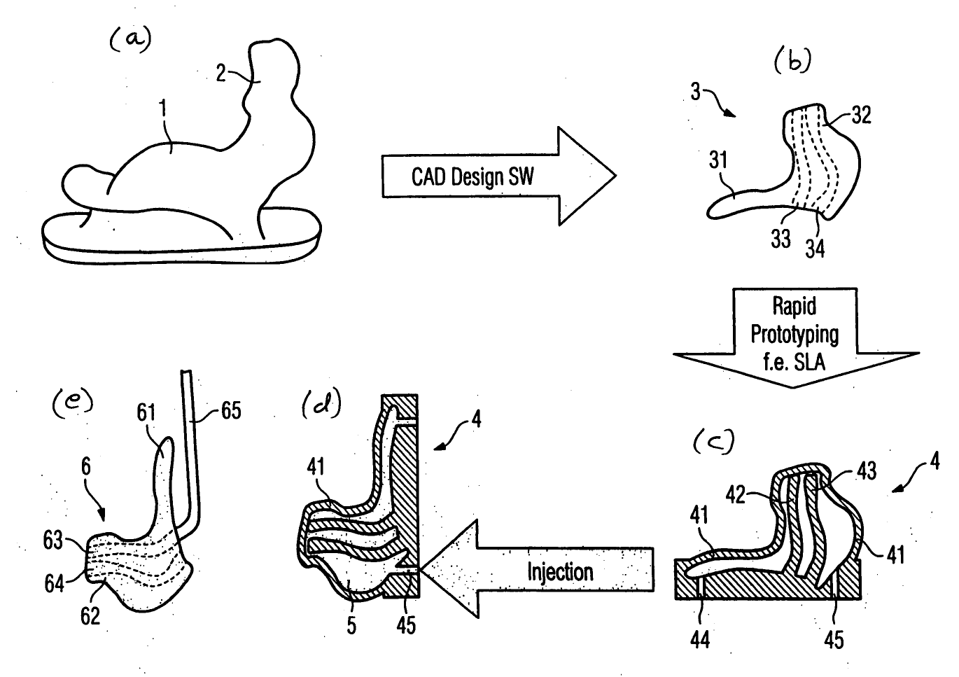

### BACKGROUND OF THE INVENTION

1. Field of the Invention

The present invention concerns a method for production of a hearing device component such as a hearing device shell, a part thereof, or an otoplastic, making use of CAD data of the three-dimensional shape of the hearing device component. Moreover, the present invention concerns a cast (mold) for production of such a hearing device component, as well as the hearing device component itself.

2. Description of the Prior Art

Modern production methods for hearing device shells and ear fitting pieces (otoplastics) use CAD software and rapid prototyping technologies. Such a method, with which the otoplastics or ear fitting pieces can be adapted to the contours of an ear canal, is known from European Patent Application EP 0 516 808 B1. As disclosed therein, the outer contours of an ear impression can be detected, for example by laser interferometry or a video camera. In addition, the possibility exists to acquire the contours of the ear channel by contact-less scanning, for example using ultrasound. The acquired data are digitized and converted (translated) by means of algorithms known from CAD-CAM technology into a three-dimensional computer representation of the outer contours of the otoplastic or the ear fitting piece. The three-dimensional computer model is thereby converted into a series of cross sections. The otoplastic is then produced by the individual cross section planes being created in succession and one atop another, under another or next to another, and then connected with one another. For example, a stereo-lithographic or similar method can be used for this production step.

This stereo-lithographic method can be executed, for example, such that a container with activated, liquid synthetic resin is arranged on a computer-controlled movable platform. A first customer-specific surface of the otoplastic can be generated by targeted use of radiation directed onto the surface of the liquid synthetic resin and thereby effecting a partial polymerization of the synthetic resin. It is subsequently necessary (respectively after production of each cross section surface) to lower the platform by the thickness of one layer so that the next cross-sectional plane can be generated in the same manner on the surface of the liquid synthetic resin. This is continued until the at least partially polymerized plastic can finally be extracted from the container.

Only a few plastics are suitable for such production methods. The material properties of these plastics in many cases do not correspond to the requirements that are placed on hearing device shells or ear fitting pieces. They plastics suitable for the stereo-lithographic production methods are normally very hard, such that the hearing devices or ear fitting pieces produced with this plastic would noticeably disturb the hearing device user, for example upon chewing.

### SUMMARY OF THE INVENTION

An object of the present invention is to produce hearing devices or ear fitting pieces that are more comfortable to wear for the hearing device user.

This object is inventively achieved by a method for production of a hearing device component by providing CAD data of the three-dimensional form (shape) of the hearing device component, generating images of negative data regarding the shape of the hearing device component, forming a negative of the hearing device component from the negative data, and casting the hearing device component with the aid of the negative.

A cast for production of a hearing device component is inventively produced by a rapid prototyping method. The inventive hearing device component can be cast from, for example, an elastic, comfortable-to-wear, skin-compatible plastic.

In accordance with the present invention, the desired earpiece or the desired hearing device shell is not produced from the CAD data. Instead, a negative is produced that can subsequently be used as an injection mold. A number of materials consequently can be used for the final product, even if not suitable for the production method of the negative.

The forming preferably ensues on the basis of the technology of rapid prototyping. In particular a stereo-lithographic method can be used for production of the negative directly from the CAD data. Very precise methods for production of hearing device shells or ear fitting pieces thus can be used without being limited to materials that must otherwise be used for these methods.

A casting mold that is produced by rapid prototyping methods such as, for example, the stereo-lithographic method, is characterized by the typical edges (surfaces) of the individual layers that are successively fashioned one atop the other. A hearing device component produced with such a casting mold also possesses the corresponding typical surface structure in the raw state after the casting. The hearing device component, moreover, possesses the characteristic layer structure.

### DESCRIPTION OF THE DRAWINGS

The single figure is a flowchart schematically illustrating the basic steps of a procedure for producing a mold, and for producing a hearing device component from the mold, in accordance with the present invention.

### DESCRIPTION OF THE PREFERRED EMBODIMENTS

As indicated in step (a) in the Figure, the three-dimensional data of a piece of an ear chamber of a patient are acquired using one of the methods mentioned above. In the present example, a concha chamber 1 and an auditory canal chamber 2 can be seen. In a circular, clockwise arrangement, the following steps (b), (c), (d) and (e) show the production process of the desired ear fitting piece that is produced in step (e). A computer model of the desired ear fitting piece (and in fact a positive 3 corresponding to step (b)) is first created from the three-dimensional data of step (a) using CAD software. This positive 3 here has a concha section and an auditory canal section 32. A sound canal 33 and a ventilation channel 34 are considered inside the computer model reproduced as a positive 3.

A negative is now calculated from the positive 3 of step (b) that exists as a computer data model, and an injection mold 4 (as schematically shown in step (c)) is immediately produced from this negative (not shown). The production of the injection mold 4 ensues via a rapid prototyping method such as, for example, a stereo-lithographic method (SLA). The injection mold 4 has an outer contour section 41, a shaped sound canal part 42 and a shaped ventilation hole part 43. The latter serves for formation of the sound canal 33 and the ventilation hole 34 from step (b). Moreover, the injection mold 4 possesses an injection channel 44 and an outlet channel 45.

The injection molding ensues with the injection mold 4 as shown in step (d). A plastic 5 that is skin-compatible and elastic is thereby injected into the injection opening 45.

The finished product 6 as shown in step (e) is extracted from the injection mold 4 after solidification. The finished product 6 corresponds exactly to the computer model 3 of step (b). It has a concha section 61 and an auditory canal section 62. Moreover, a sound passage 63 and a ventilation channel 64 are fashioned in the ear fitting piece. It can also be see from step (e) that a sound tube 65 was inserted into the sound channel 63 after the casting of the ear fitting piece.

In the production of the ear fitting piece corresponding to steps (a) through (e), a negative form suitable as an injection mold is thus directly calculated in an inventive manner from the CAD data of the desired earpiece. This negative form arising from data can now be directly translated into a physical injection mold via an exact prototyping method. Any injection-capable materials which distinctly increase the wearing comfort of an hearing device or ear fitting piece can now be used for the injection molding.

Although modifications and changes may be suggested by those skilled in the art, it is the intention of the inventors to embody within the patent warranted hereon all changes and modifications as reasonably and properly come within the scope of their contribution to the art.

I claim as my invention:

1. A method for producing a hearing device component, comprising the steps of:
providing CAD data of a three-dimensional shape of a hearing device component
forming negative data for the shape of said hearing device component from said CAD data;
casting a negative mold of the hearing device component from the negative data;
casting the hearing device component using said negative mold.

2. A method as claimed in claim 1 comprising casting said negative mold using a rapid prototyping technique.

3. A method as claimed in claim 2 comprising employing a stereo-lithographic technique as said rapid prototyping technique.

4. A hearing device component produced according to the method of claim 1.

5. A method for producing a casting mold for a hearing device component, comprising the steps of:
providing CAD data representing a three-dimensional shape of a hearing device component;
forming negative data with respect to the shape said hearing device component; and
casting a negative mold of said hearing device component from said negative data using a rapid prototyping technique.

6. A method as claimed in claim 5 comprising employing a stereo-lithographic technique as said rapid prototyping technique.

7. A casting mold for a hearing device component produced according to the method of claim 5.
